(19) United States
(12) Patent Application Publication
(10) Pub. No.: US 2002/0077832 A1
(43) Pub. Date: Jun. 20, 2002

(54) Computer based integrated text/graphic document analysis

(76) Inventors: Batchilo Leonid, Belmont, MA (US); Tsourikov Valery, Boston, MA (US); Edward Dreyfus, Clark, NJ (US)

Correspondence Address: STANGER & DREYFUS, 608 SHERWOOD PKWY, MOUNTAINSIDE, NJ, 07092, US

(21) Appl. No.: 10/003,707

(22) Filed: Nov. 2, 2001

Related U.S. Application Data
(60) Provisional application No. 60/282,078, filed on Apr. 6, 2001.
(60) Provisional application No. 60/246,015, filed on Nov. 6, 2000.

(51) Int. Cl. G10L 21/06

(52) U.S. Cl. 704/276

(57) ABSTRACT

A computer system based method of analyzing an electronic document which document includes text and graphics and common reference symbols designate text components and respective graphics components the method comprising processing the document text and graphics into an index that identifies the text locations of reference symbols and graphic locations of reference symbols, and displaying (70) the text that includes at least some of the text reference symbols and/or displaying (68) at least some of the graphic reference symbols, and linking the common text and common graphic reference symbols such that user selection of a particular text reference symbol or graphic reference symbol causes display of a respective graphic segment or text segment that includes the selected common reference symbol. Other features include displaying a component list, selecting component identities to display graphic segments, using voice recognition for user control, and synthesized speech for audio text response.

### RELATED APPLICATIONS

This application is a continuation-in-part application to U.S. Provisional Patent Applications No. 60/282,078 filed Apr. 6, 2001 and S No. 60/246,015 filed Nov. 6, 2000.

### BACKGROUND

The present invention relates to computer-based systems for retrieving, displaying, managing, and analyzing electronic documents that include text portions and drawings or graphic portions. One class of such documents includes patents and published patent applications of the U. S., W.I.P.O., other countries, and territorial patent offices of the world. As is commonly known, a vast number and all future such patents and published patent applications are available on-line for computer retrieval from publicly available government and commercial databases and from disks supplied by various entities. Typical users include government patent examiners, patent attorneys and agents, engineers, scientists, inventors, corporations, government agencies, universities, technology and searching services, and laboratories, and other individuals interested in obtaining and evaluating such documents.

Various present day database management entities provide server and PC resident software facilities to aid the users to search for, find, and download specific patents or candidate patents for analysis. Users can undertake manual, Boolean, patent number, assignee, inventor name, invention class and sub-class and many other types of searches.

Once a patent examiner or other user accesses and displays a candidate patent, user usually needs to quickly read and understand the content of the document disclosure. Often times the published abstract is insufficient to convey the detailed information required for particular tasks thereby forcing the user to scroll through the specification and drawings for content. However, a technical problem exists with present systems in that they lack the ability to integrate the textual information with the drawing information thus slowing the users efforts and increasing the user's analysis time.

### SUMMARY

It is a principal object of the present invention to provide a programmed computer system and method that effectively displays, in a flexibly user managed manner integrated document text/graphic subject matter for user's rapid understanding of that subject matter.

Another object of the present invention is to solve the foregoing problems by computer analysis of the graphics and text information of an electronic document and present precise integrated text/graphic information to the user on the specific component, components, or functions of interest to the user and enable user to manage the integrated display of such information.

Another object of the present invention enables user to control the modes of computer presentation. For example, user can designate integrated text/graphic display on the computer monitor of precise drawing segments that include a user designated component and precise text segments that include the same user designated component. Alternately, the system can display on the monitor full figures of or drawing segments of a user designated component and the system can use synthetic speech software to “speak” the text segments that include the same user-designated component or functions or processes. In this latter mode, user can concentrate on the graphic information while listening to the text description of the structure and/or operation of the same graphic information.

Another principal object of the present invention is to solve the above mentioned problems and provide a system and method that not only integrates the text and drawing information for simultaneous display of both text and drawing information but also manages the text/drawing display of the precise component, components, or functions of user's interest while omitting non-relevant data from the integrated graphic display and text display and/or audio.

Exemplary embodiment of the present invention includes using the software-based system disclosed in U.S. Pat application Ser. No. 09/541,182, filed Apr. 3, 2000 by the assignee hereof to semantically process the natural language text into subject-action-object (SAO) structures. Since all S's (subjects) and O's (objects) are nouns, or noun groups, (hereafter jointly and severably noun groups) many noun groups in a given patent disclosure would be associated with and include a reference number in the text that, of course, corresponds with the reference character shown on one or more drawing/Figures. For example, it has been found that the semantic processing by the system of the aforementioned patent application identifies a noun group in U.S. Pat. No. 5,974,616 as “sound chamber 19” and not simply “sound chamber”. In addition, the system can identify alternate text names given in the patent text for the same component for more reliable display or audio of pertinent information.

According to principles of the present invention, an exemplary embodiment includes a reference number recognition software module to recognize and identify those reference numbers in respective drawing sheets and their respective X-Y grid locations and an index linking each reference number with the respective number of each subject (noun group) and each object (noun group) in the text. Since the linking index bilaterally associates the drawing reference number to the noun group in the text, user can quickly display the precise text and patent drawing graphic by selecting either the number in the drawing or the noun group text segment as more fully described below. Because the noun group is recognized by the processing software, the noun group words can be highlighted to aid the user to quickly find and/or understand the content.

An exemplary embodiment of the inventive system enables a user to call up, download or otherwise access a document or documents, such as one or more U.S. issued patents. The system processes the document to generate the index that includes bilateral links between all text phrases that include reference numbers and all drawing segments that include the same respective numbers. User can scroll through the text and click on/select any numeric reference character (hereafter reference number) in the text. The system then automatically displays the segments of drawings that include that reference number. Also, it is preferred that, either automatically or by user selection, all sentence segments or phrases containing the reference number and/or the word(s) associated with the RN throughout the patent are also displayed so that the user can quickly read the various phrases while looking at the displayed drawings segment(s). As mentioned above, user can also select (click on) a “speak” button which will activate computer speech module which “reads” and “speaks” to the user the text segments over the computer speakers while user concentrates on the drawings. In addition, an “Expand” button can be selected by mouse or voice recognition which will cause the system to display and/or “speak” a given number of words or sentences before and/or after the displayed and/or “spoken” text segment.

Another aspect of the system enables user to display and scroll through the drawings, then enter a reference number or click on a displayed reference number or alternately the associated noun group. The system then displays all or at least one drawing segment(s) and all or at least one text phrase(s) that includes the selected number or noun group. If desired, clicking on a specific displayed text segment, can display the full text including from several lines before to several lines of text after the selected text segment, which text is then scrollable under user command throughout the text document as described.

Other features of the invention include (i) enabling the user to “zoom in” to omit non-relevant or “zoom out” to include more relevant drawing information, (ii) identifying the drawing sheet number and X, Y coordinates of the displayed drawing segment, (iii) displaying the sheet number, Figure number of each segment, (iv) and providing a link from a displayed text phrase to the full text segment (paragraph) with forward and back text scrolling capability through the entire displayed patent text, (v) expand or reduce the text window and graphic window sizes.

A further feature of the present invention includes processing large numbers of documents and storing the relevant data of these documents in an indexed knowledge base to support a local or an on-line service or capability. Users accessing the system (either locally or on-line) shall have the above process features available for documents, such as patents, previously processed and stored.

An alternate embodiment simply identifies and stores in a linking index the text locations of each reference number and related noun groups and the drawing location of each reference number. User can select (highlight) or enter a particular reference number from a displayed text segment and the relevant drawing segment(s) will be displayed or user can select the number in a displayed drawing and the system will display all the text segments that include such number. In either case, selection of the text segment initiates display of a larger text segment fore and aft of the reference number, which larger text segment is scrollable by user command. This embodiment, with little or no semantic processing to identify the noun groups, is less effective in identifying the noun groups or synonyms associated with the reference number and may not identify the noun group unless the textual noun group contains the reference number. Noun groups that do not contain a reference number may be missed. Nevertheless, this embodiment enables text—drawing displayed integration to some degree.

Yet a further optional feature of the present invention is a system of the type described in which a list of all components (e.g. noun groups) including respective reference numbers is displayed initially alone and/or together with a text window and/or the graphics window. In one example, the list is arranged in order of reference character or alphabetical by noun words. User can change the parsing rule by clicking on an icon. The component list window, the text window, and the graphic window can be expanded or narrowed as desired under user control to provide less or more area for the other window or windows. The component list quickly reveals to user all the components (noun groups) in the text and drawings that the systems associates with reference symbols. User can quickly select, click on, the component user is interested and, in response, the system displays in the text window the text segment and, preferably, the text fore and aft of this segment. The system then provides a number of ways for user to select either text segment or component list component to display the graphic segment that includes the reference number of interest.

### DRAWINGS

Other and further features, objects, and advantages of the present invention shall become apparent with the following detailed description of exemplary embodiments when taken in view of the appended drawings in which:

FIG. 1A is a computer monitor showing approximately two paragraphs from U.S. Pat. No. 2,974,616 which text and related drawing shall be used to illustrate various exemplary embodiments and features of the present invention. It will be understood that the full text of the patent is scrollable (not shown) and managed as described below.

FIG. 1B shows one example of tagging each text word with a unique identifier (ID), which is internal to the computer system and not displayed to the user.

FIG. 2A is a diagrammatic representation of a linking index or table within the computer system according to the principles of the present invention. It should be understood that this index does not physically exist as such but instead is a functional representation of interactions among programmed data bases and files and routines embodied in the computer system.

FIG. 2B is one example of a flow diagram for user operation of the method here of involving users PC processing of the subject document.

FIG. 2C is similar to FIG. 2B for a remote server processing of the subject document.

FIG. 2D is a more detailed flow diagram of processing the subject document information into a functional linking index.

FIG. 3 is one example of a screen shot displayed when reference number “18” is entered into window 34 of FIG. 1A or selected (clicked on) from text by FIG. 1A.

FIG. 4 is similar to FIG. 3 when anyone of “Sheet 1” of FIG. 3 is selected by user.

FIG. 5 is similar to FIG. 3 when “sound chamber shell 18” of FIG. 3 is selected by user.

FIG. 6 is similar to FIG. 5 when “sheet 1 FIG. 3” of FIG. 5 is selected by user.

FIG. 7 is similar to FIG. 3 wherein user selects sheet 1 and removes 18 from box 34 to hide text related to reference numbers.

FIG. 8 is a pictorial representation of the data resulting from user selecting “19” in FIG. 3, hereof.

FIG. 9 is similar to FIG. 8 in which user selected sheet 1 in FIG. 8. Links to full text are represented by arrows A.

FIG. 10 is schematic representation of a typical system for implementing the present invention.

FIG. 11 shows one example of the main stages of a speak module for “speaking” text portions.

FIG. 12 shows a screen shot of yet a further exemplary embodiment according to the principles of the present invention.

FIG. 13 shows a screen shot similar to FIG. 12 after “16” in window 68 of FIG. 12 was selected.

FIG. 14 shows a screen shot similar to FIG. 13 after the underline noun group of window 82 was selected.

FIG. 15 shows a screen shot similar to FIG. 14 after the text noun group highlighted in window 70 was selected and sheet #1 was selected by user.

### DETAILED DESCRIPTION OF EXEMPLARY EMBODIMENTS

A glossary appears at the end of this detailed description.

An exemplary embodiment according to the principles of the present invention will now be described. Actual text and drawings from an actual patent shall be used as one example to illustrate the principles and power of the present invention.

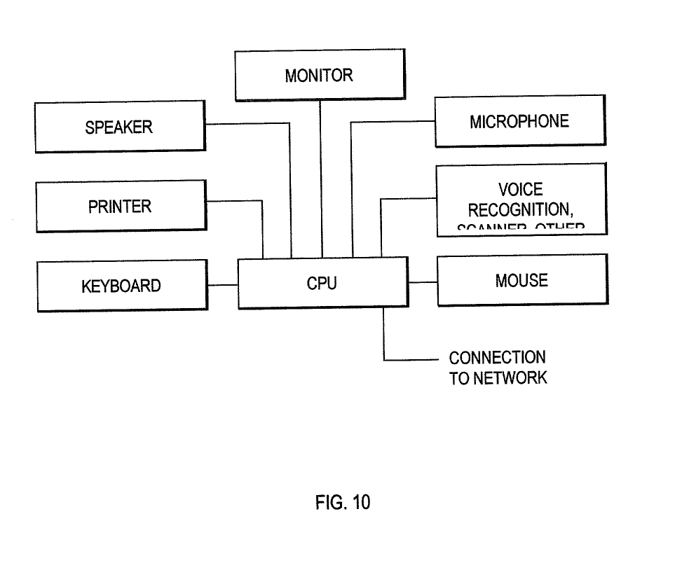

A typical apparatus for implementing the present invention is shown in FIG. 10, that includes a general purpose computer system 10 with CPU, memory, etc. suitable data entry and user interface devices such as disk reader, keyboard, mouse, scanner, voice recognition, etc., a modem or other communicating device, a monitor and printer, and other standard devices (internal and external) as desired. System 10 can be programmed to implement the inventive method hereof or access a remote server programmed to enable user and other users to implement the present method.

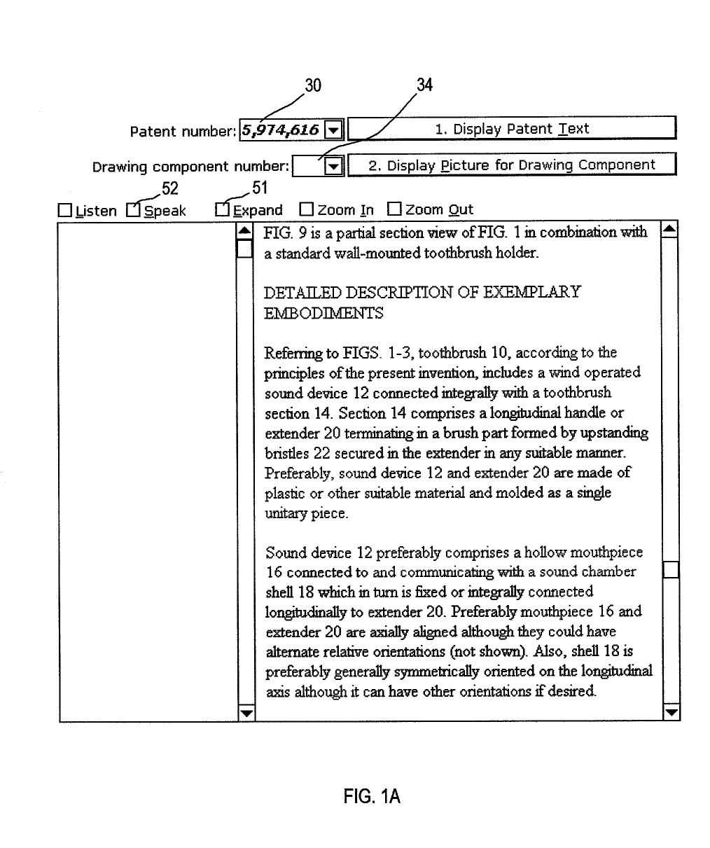

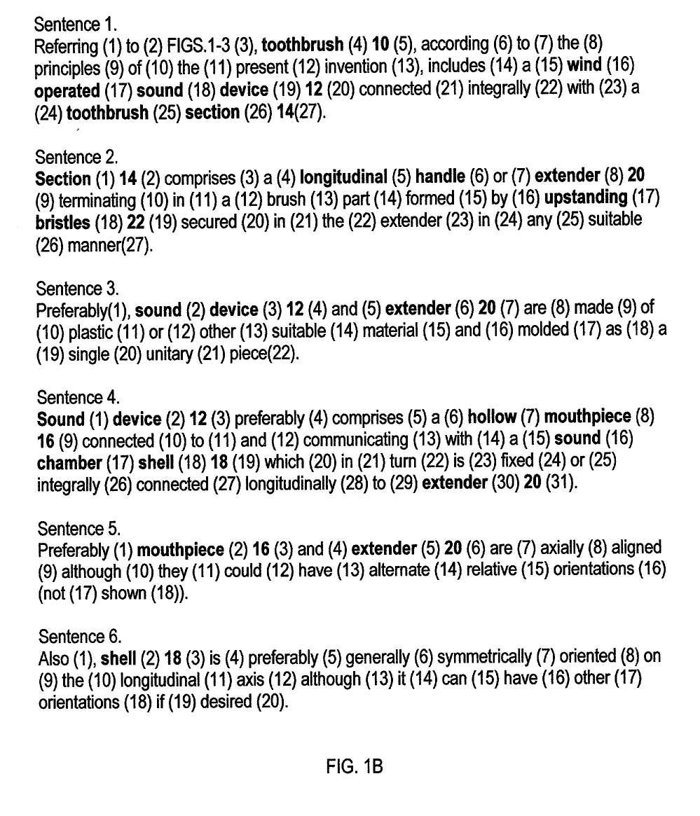

One example of the present process and apparatus shall be described using two paragraphs of U.S. Pat. No. 5,974,616 as shown in FIG. 1A. It will be understood only two paragraphs are being used for simplicity only and that, indeed, the entire patent is processed in the actual system.

In one preferred exemplary embodiment of the system and method of the present invention, the text of FIG. 1A is preferably, but not necessarily, semantically processed according to the principles of the system and methods of U.S. patent application Ser. No. 09/321,804 filed May 27, 1999 and U.S. patent application Ser. No. 09/541,182 filed Apr. 3, 2000. Other known syntax based processing software may be used preferably such that it associates the reference number with respective noun or noun group. Alternately, software may be used that simply treats the reference number as a bilateral link between the drawing segments and text segments where both include the same reference number.

Component Text ID and Location

The text of FIG. 1A preferably is semantically processed by the computer and software, e.g., disclosed in U.S. patent application Ser. No. 09/541,182, filed Apr. 3, 2000, to identify each sentence and each word of the text. At this stage, each reference number is treated as a separate word. Accordingly, the text of FIG. 1A is internally processed into the six sentence, word identified text of FIG. 1B. The computer stores this data and identifies various natural language elements including noun groups. Note the noun groups are identified (highlighted in FIG. 1B) and each word is identified with a unique number, such as sentence 2, word number (9), identifies the reference number “20”.

Drawing Component Reference Number ID and Location

The present system also recognizes each reference character on each figure of each sheet of drawings in the patent. Several standard software products are presently marketed that provide such capability, e.g. the Fine Reader™ software sold by ABBY Software House http://www.abbyyusa.com/products/fine/index.htm; PenReader™ software sold by Paragon Software http://www.penreader.com/penreade.htm; and others generally known to those of ordinary skill in the art. More reliable results are achieved if the system includes software that processes graphic data by deleting all data except numbers. The reference number data and locations can then be more reliably identified. Accordingly, the patent drawings (sheets) are processed not only to identify specific reference characters but also their X-Y grid or pixel location on specific sheets. If desired, the lead-line location for each identified reference number can also be identified. The computer stores this graphic data.

Linking Index

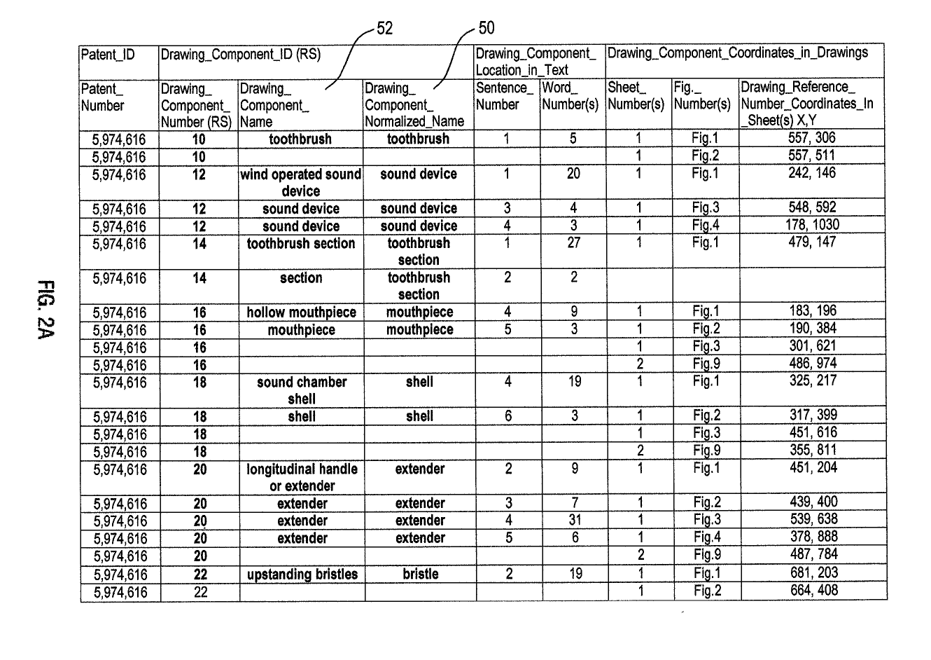

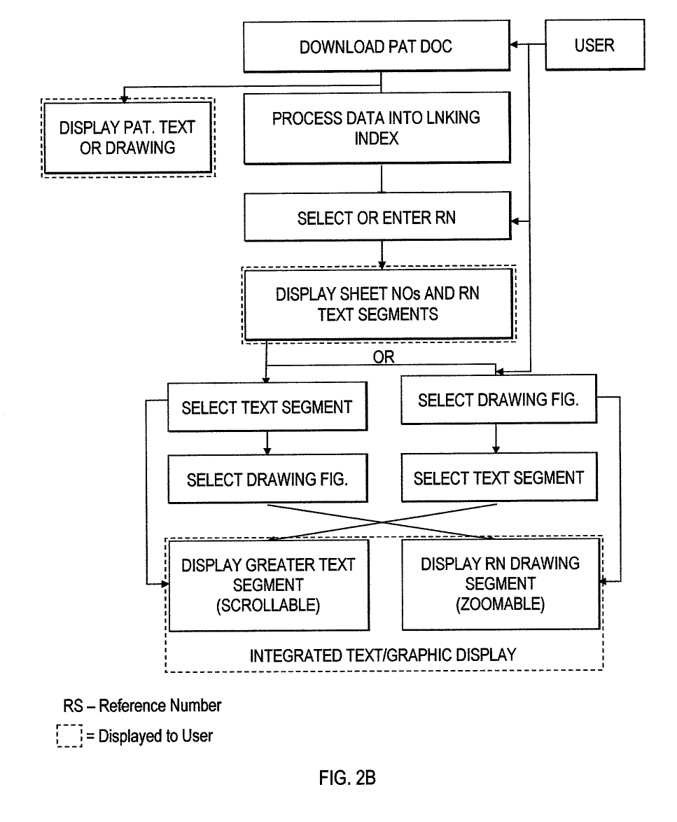

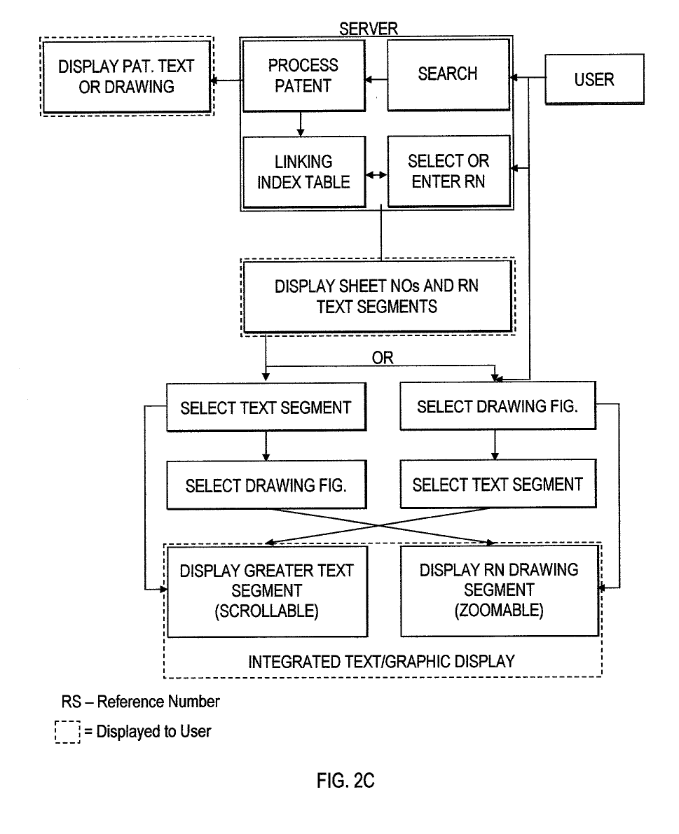

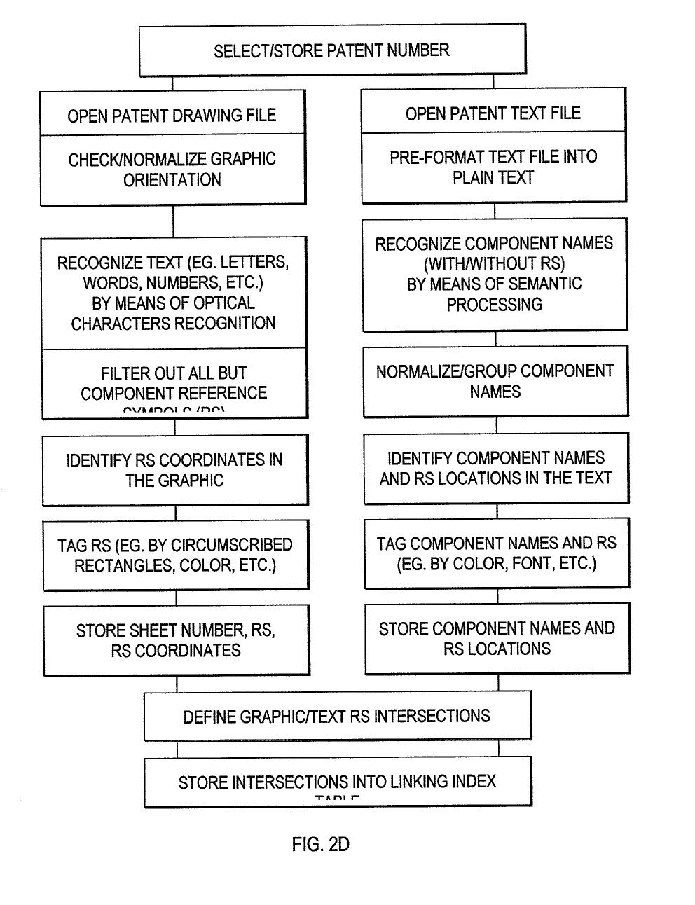

According to the present invention, the text locations and drawing locations of common reference number components are linked by the computer for later manipulation and management. One exemplary system and method for such linking includes linking the reference number in the text and its locations with the reference number locations in the drawings. One way to implement this is for the system and method to include a linking index, one example of which is shown in FIG. 2A. Here the patent number (or other document ID), the drawing component reference number (RN), sheet number in which the reference number appears and position on the sheet the reference number appears and the sentence and word numbers of the reference number are all stored in association with each other so that user selection of either the displayed drawing component number (reference number) or the displayed text segment or text reference number can, through standard linking techniques, initiate the display of the other. Further, user selection of the displayed reference number text segment or the noun groups in which it is displayed can, through standard linking techniques, display the full sentence in which the selected text segment or reference number appears. If desired or in response to user command, the system displays the preceding text and subsequent text thereto with the capability enabling user to scroll forward and backward through the entire document text, if desired. Although sentence number and word number are shown, it will be understood that page number and word number, or word count number (from word number 1 through word number N, where N is the last word of the document), or some other word ID location technique can be used. Also, instead of grid location, some other suitable reference number location ID on the drawings can be used, such as vector length/angle from a predetermined point on the sheet, e.g. upper left corner of an A4 sheet. Alternately, precise pixel locations and designations can also be used.

Listen/Speak Commands

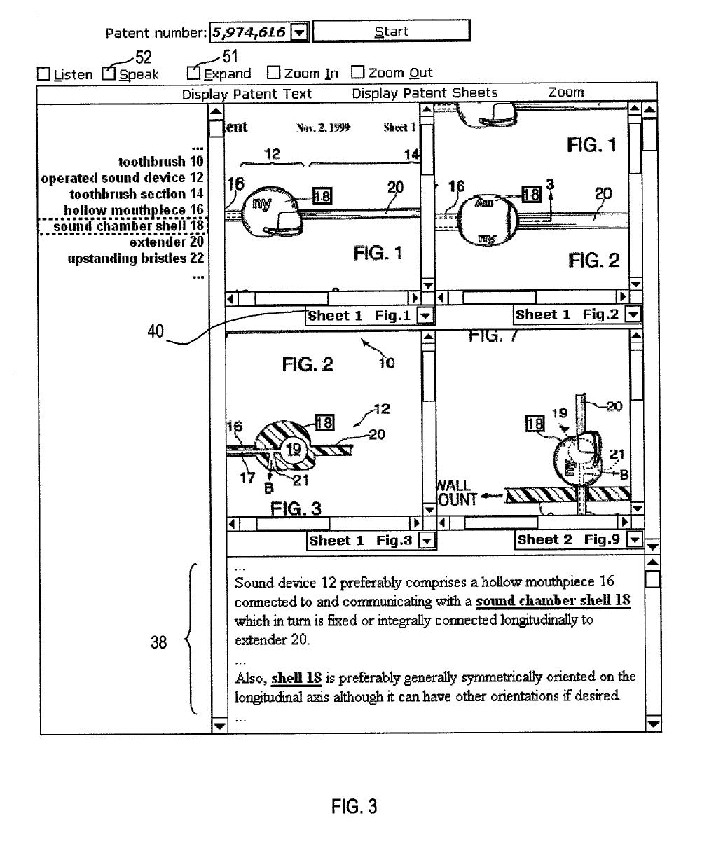

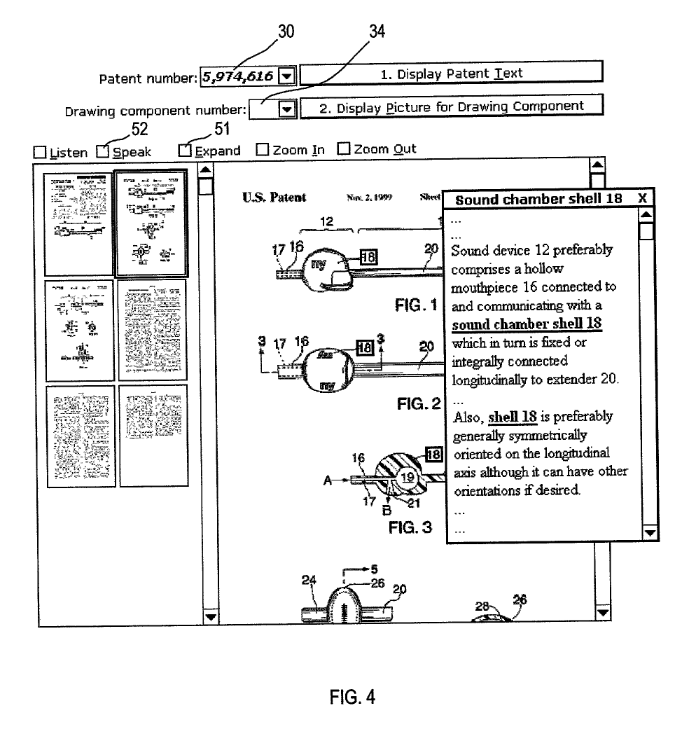

As seen in FIGS. 3-9, an exemplary system according to the principles of the present invention can include a “listen” button and a “speak” button. Selecting or clicking on either button will activate the respective mode. The “speak” function (or any other function user described herein) can be activated by the user speaking a code word or phrase such as “computer listen” or “computer speak” or any other desired and pre-stored word or phrase. Deactivation of the speak or listen function can be initiated by user repeating the button click or verbal command or some other pre-stored verbal command such as “stop speak” or “stop listen” or “plug ears”.

Each of these functions provide substantial benefit to the user because user need not use mouse or keyboard in order to select one or more reference numbers, noun groups, or functions of interest. For example, to obtain the data for U.S. Pat. No. 5,974,616 shown in FIG. 3, when in the “listen” mode, user can simply say “18” or “computer, 18” and the FIG. 3 data appears. If user wants more graphic information, user simply says “zoom out” and greater areas of the drawing segments appear. If now the user wants to see all drawing segments that includes a different reference number, e.g., reference number “14”, user can simply say “14” or “computer, 14” and the displayed graphic is replaced with the respective figures segments with “14” in them which appear along with the text segments/sentences that includes “14”. If user says “mouthpiece” the above is repeated as if user said “16” because the index links the word and the number. As seen below, if user enters or says a function or action, e.g. “rinse”, the system displays or “speaks” one or all sentences with “rinse” in them.

Also, and independently, if user is viewing graphics on the monitor and initiates the speak mode then user can continue to concentrate on the graphics and simply click on or say “18” or “speak 18” and the computer synthetic voice shall “speak”, in sequence, each sentence or sentence segment of the entire document text that includes the reference number “18”. This mode yields great benefit because user can concentrate on the graphic content while listening to each sentence or sentence segment in which “18” appears. In addition, if user wants to listen to sentences with another reference number, e.g., “14”, user simply says “14” or “speak 14” and the computer then “speaks” in sequence each sentence or segment that includes reference number “14”. If desired, the graphic display can change to those segments that include “14” and user can say “zoom in”, “zoom out” as desired. In addition, user may want an oral description of text sentences that include elements, actions, functions, etc. that do not have a drawing or text reference number, such as “liquid” in U.S. Pat. No. 5,974,616. Thus, according to the inventive principles, if, when analyzing said patent in the “listen” mode, user says “speak liquid” then the computer voice shall “speak” all sentences with “liquid” in them including the sentence at col. “3”, lines “30-36” where it describes “liquid” drains through from chamber “19”, channel “17”, etc. Note, “liquid” has no reference number, but the present method nevertheless promptly speaks and/or displays the sentences with “liquid” in them for fast user comprehension of the text/drawing disclosure. Alternately, if desired, user could type in the word of interest (“liquid”) instead of speaking it in the “listen” mode with the same results.

There are several text-to-speech commercially available software packages available to implement the “speak” function in a digital computer, such as IBM's VIAVOICE™ software. It can also be used to implement the “listen” commands and verbal commands described above.

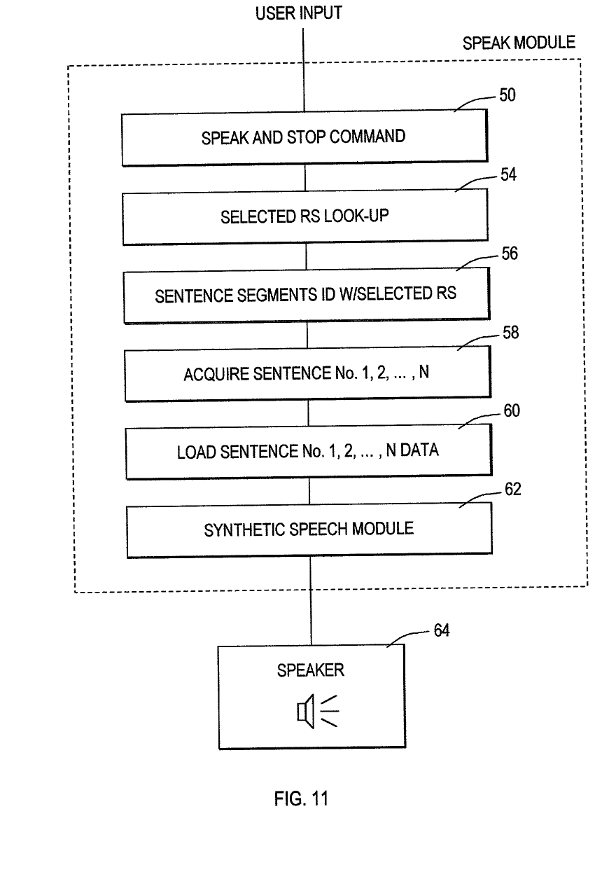

With reference to FIG. 11 hereof one exemplary method of implementing the speak and stop speak function includes initiating the “speak” and “stop speak” commands 50 by the user, which in the “listen” mode, saying “speak” or “stop speak”. In response, the current reference number that had been or shall be selected by the user is acquired at 54. In response, the sentence segments with the selected reference number are identified at 56 from the index and then acquired in sequence, at 58 and loaded in sequence at 60 to drive a standard synthetic speech module at 62 for driving speaker 64.

If during the computer “speak” of any particular sentence or segment, user clicks on the expand button 51 or says “expand”, then the full sentence before and the full sentence after the current sentence or segment in the text are acquired at 58 and the three full sentences are “spoken” to user in proper order.

Expand Commands

User may desire to quickly see or hear the sentence or two before and the sentence including and the sentence or two after a displayed or “spoken” sentence segment. One example of the present system includes an “expand” button or an expand voice recognition command capability. The system can display these sentences in response to an expand command from user in a number of ways. User can click on a displayed segment to initiate the expand command or click on the “expand” button during the synthetic “speak” of a particular text segment, or when in the “listen” mode, simply say “expand” while the cursor is placed on a segment.

User Display and Interaction

In this example, user is interested in quickly understanding patents relating to tooth brushes with sound devices. User can, of course, undertake standard Boolean key word searches of the U.S. Patent & Trademark Office databases to obtain candidate documents for his/her analysis or use any conventional search engine to access candidate patents or use other conventionally on-line engines such as WWW.COBRAIN.COM. [COBRAIN is a registered trademark of Invention Machine Corporation, Boston, Mass.] Assume user identified U.S. Pat. No. 5,974,616 for analysis. User enters or selects from a displayed list (not shown) the patent number to appear in window 30 on the screen of FIG. 1A, which initiates the processing. The system processes the '616 patent and automatically enters data in the linking or table index. See FIGS. 2A and 2B. Note only the six sentence text in FIGS. 1 and 2A hereof are used in this example. FIG. 2 shows the table data for these six sentences. It will be understood that the entire patent should be processed and data entered in the FIG. 2A table, but for simplicity, only the six sentence data is shown. Further detail of one exemplary method of processing patent data into a linking index is shown in FIG. 2D.

Initially windows 34 of FIG. 1A is blank and the full patent text is displayed. In reading the document user sees that “sound chamber shell” is associated with reference number “18”. User can click on any “18” or highlighted associated noun group or enter “18” in window 34 and the system will display in window 38 the text segments in which “18” appears and the sheet numbers and figure numbers in which the reference number “18” and related component appear see FIG. 2B. User can quickly read the text segment(s) 38 of FIG. 3. If user selects (clicks on) “Figure Number(s)” 40, then the system will display the relevant figure segments, in this example FIGS. “1”, “2”, “3”, and “9” of the subject patent, in which reference number “18” appear. See FIG. 3 hereof. Alternately, the relevant figure segments including “18” can be displayed along with segments 38 when the drawing reference number is first selected to display the text segments.

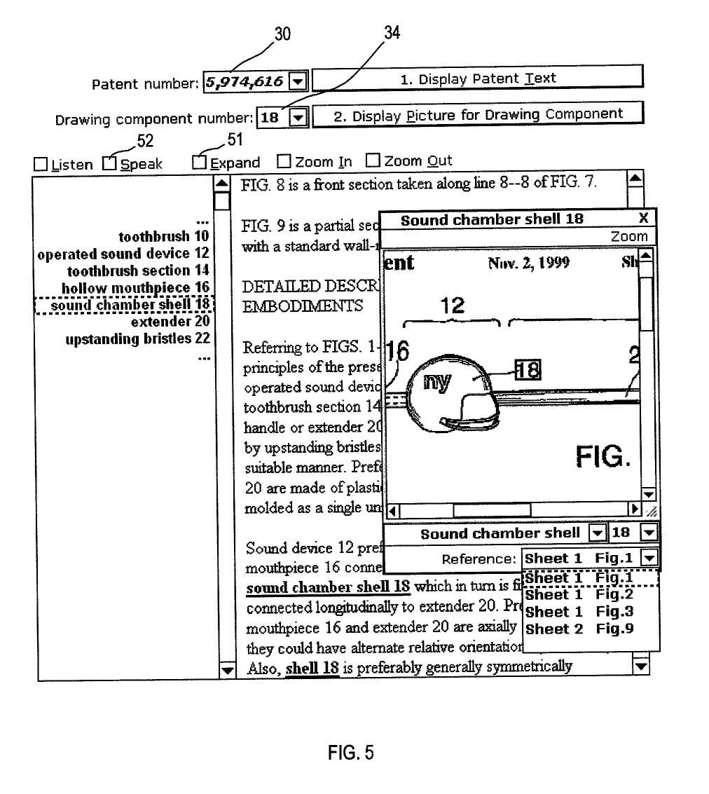

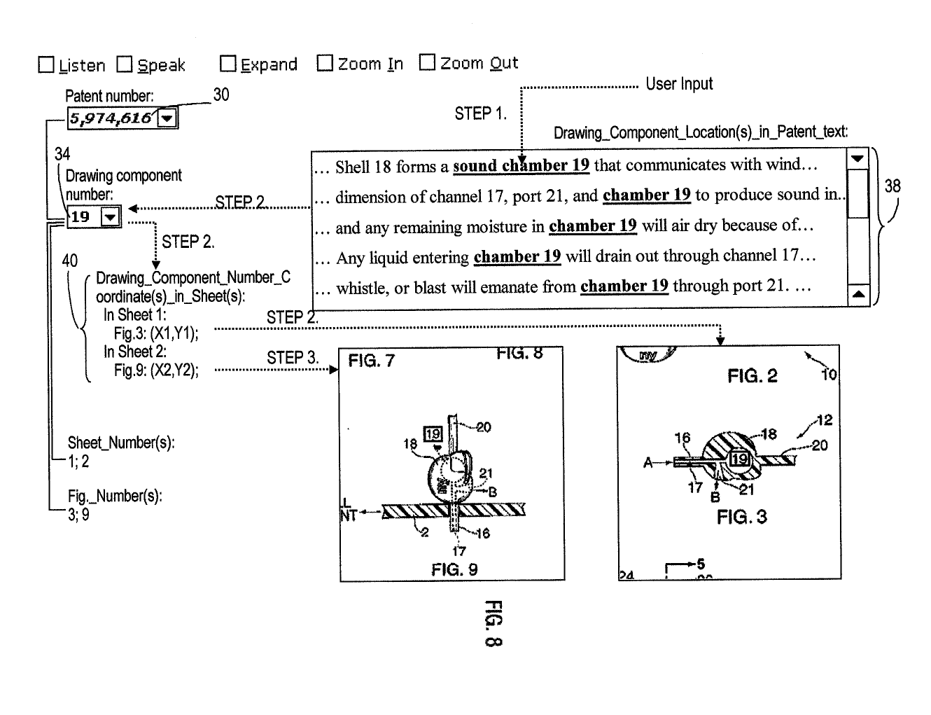

Preferably, user can zoom out or in to display more or less drawing information around the reference number “19” component. If user selects “sheet number” 40 a second time, or alternately gives some other programmed command, then the system will display the full sheet or all of the sheet figures with reference number “18” in them as in FIG. 5 hereof. The user can enlarge or reduce the displayed size of the sheet as desired with standard software techniques. The text segments can be displayed also as shown in FIG. 3 or alternately FIG. 8.

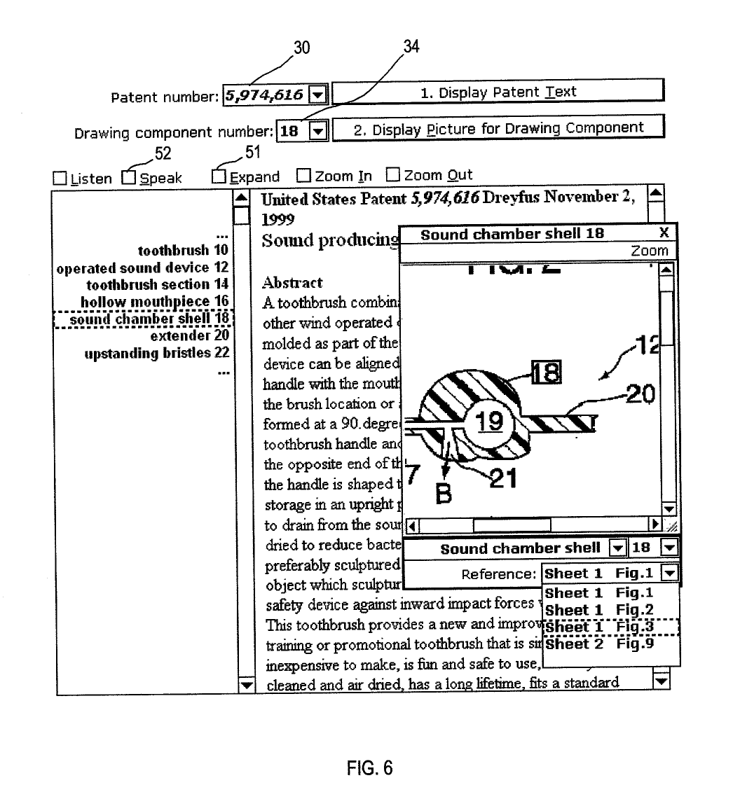

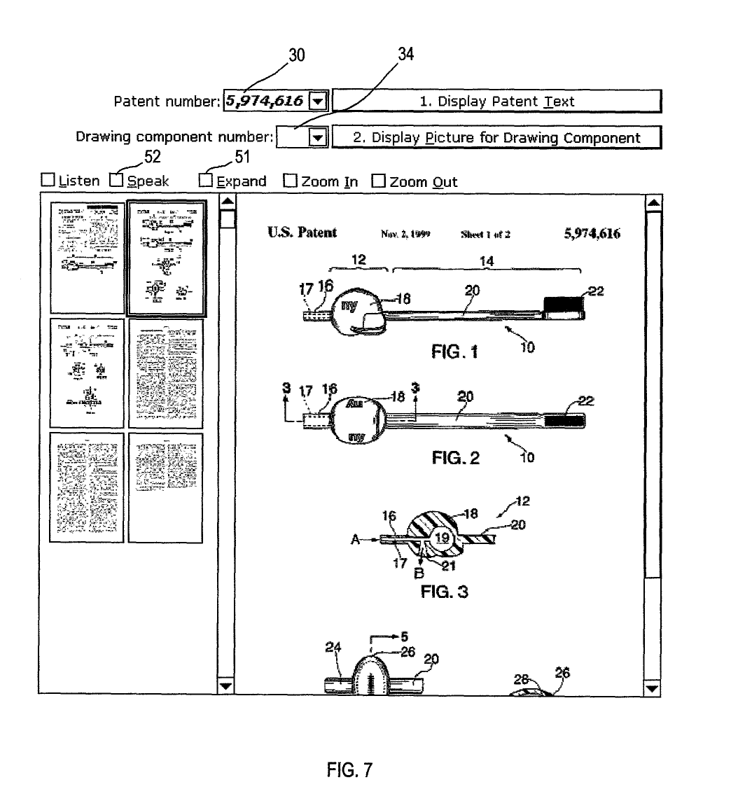

User can also display the full text and one of the figure segments as in FIG. 5 hereof and select an alternate drawing segment as in FIG. 6, hereof. Lastly, user can initially select a graphic sheet for display or later hide the text and scroll the entire drawing sheet as shown in FIG. 7 hereof where sheet no. “1” as selected by user in the left window to display sheet no. “1” in the right or graphic window.

As mentioned above, user can select any of the displayed text segments 38 and the system will display at least the full sentence, and preferably more text, in which the segment appears in the text.

User, of course, can select other reference numbers as desired to display the text segment(s) and relevant drawing segments both of which include the selected reference number. It will be understood that the system effectively displays, in a flexible user managed manner integrated document text/graphic subject matter for user's rapid understanding of that subject matter.

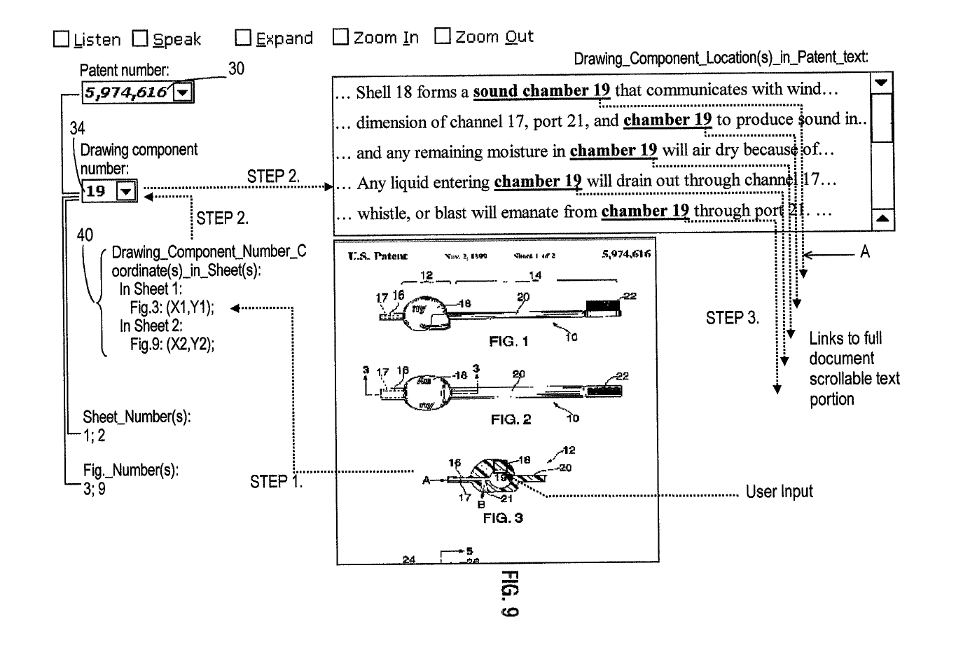

For example, assuming the user notices component “19” in the drawings and wants more information about that component, user simply clicks on “19” in any of the figures or enters “19” in window 34. The system, in response, determines from the data in the linking index (data not shown) the text segments and drawing segments associated or linked to reference number “19” and displays all the text segments and all drawing segments that include “19”. See FIG. 8 which includes the first five segments related to sound chamber “19”. In addition, links to the drawing segments (e.g. “Sheet 1, FIG. 3” and “Sheet 2, FIG. 9”) are displayed and, preferably but not necessarily the drawing segments around component “19” are also displayed. See FIG. 8 hereof.

It will be understood that the data in FIG. 8 would be displayed in a suitable format, such as that shown in FIG. 8 or that format shown in FIG. 3, hereof. In either case each text noun group also can function as a link to the full paragraph of text in which the segment appears (see FIG. 9, hereof) and such text would be scrollable in the usual manner. The displayed drawing segment, likewise, function as a link to the full sheet of drawings such that user selection calls up for display the full drawing sheet. See FIG. 9, hereof.

The above method can be repeated for other reference symbols names or drawing components or functions/actions of interest to user, which enable user to manage the integrated text/drawing viewing in an extremely effective and efficient manner.

At anytime during the analysis of the '616 patent, user can enter the “speak” and/or “listen” mode described above. If while in the “listen” mode the FIG. 7 information is displayed, and user says “speak 19” then the computer speaker “speaks”, in sequence, each text segment that includes “19” while user concentrates on the drawing or drawings being displayed. During the “speak” of anyone segment, user can click on or say “expand” and the sentence before, after, and upon the current segment will be “spoken” by the system. In addition, user can say “liquid” and all sentences with the word “liquid” shall be “spoken” by the system. Note “liquid” does not have a reference number and does not appear in the drawings. Nevertheless, user is interested in how the drawing parts function with or relate to “liquid”.

If user wishes to end the analysis of Patent 5,974,616, user deletes the patent number from window 30 or enters into window 30 the next patent number for analysis and clicks OK to start the next analysis.

An alternate embodiment mentioned above with little or no semantic or syntactic processing, includes a table or linking index similar to that shown in FIG. 2A but without the column 50 and 52, and respective data. If without both 50 and 52 data, linking between text and drawing and text selection, would be responsive to reference number selection or designation and not noun group that include the RN selection or designation. The speak/listen commands can also be implemented without 50 and 52 data, if desired.

The above example assumed the document was processed in the user's PC as, EG, in FIG. 2B. The above example also pertains to the system and method in which the document is processed in a centralized or remote server or the like accessible to the use (and other users) via networking. See FIG. 2C.

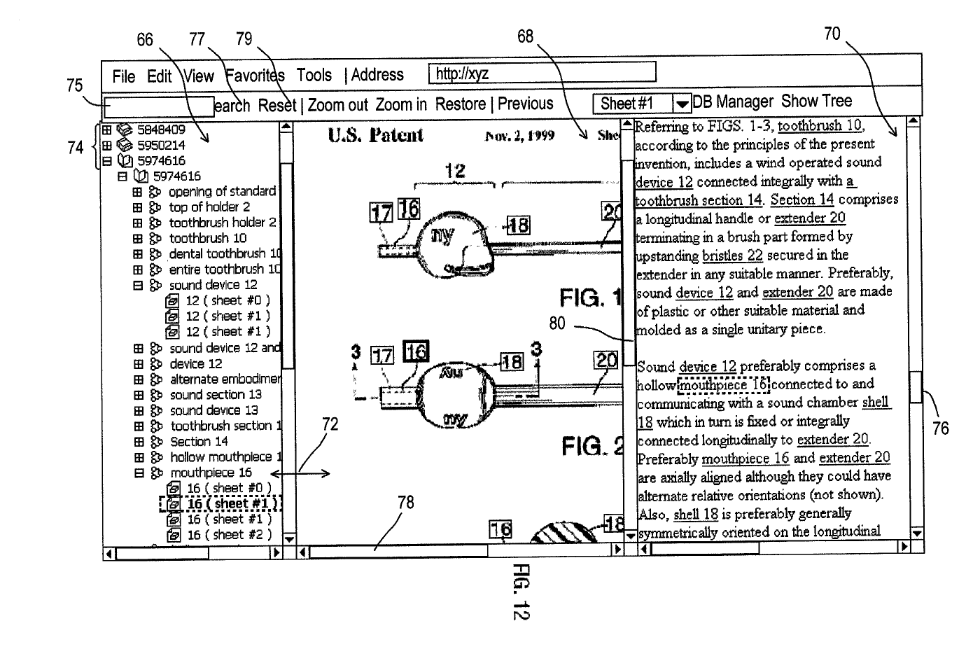

A further exemplary embodiment according to the principles of the present invention is shown in FIGS. 12-15 in which the computer system can generate preferably three windows, a component list window 66, a graphic window 68, and a text window 70. The width or area of these windows on the monitor can be varied as desired by user command in the usual manner, such as dragging a control arrow 72 at the window(s) boundary. One mode of operation and data management of this embodiment includes processing in a remote server a number of patents to generate the linking index as mentioned above.

In this example, the processing server is remotely accessible by user's PC commuter at website http://xyz. The user had previously designated to the server by any suitable conventional method for processing the patents listed at 74 and the server acquired by them on-line and processed and stored these identities and patents in user's file for ready access and analysis. It is assumed for purpose of illustration that all listed patents 74 relates to sound producing toothbrushes and were processed into the full linking indexes similar to FIG. 2A hereof. User then opened (clicked on) number 5,974,616 to begin user analysis of this patent.

The system in response to users patent selection preferably displayed the component list of each component which preferably includes a reference number (RN). This list can be organized in order of RN, as shown in FIG. 12, or alternatively in alphabetical order of main noun word in the component noun group. User can quickly scan the list and select the component of interest to user, or user can enter a component word of interest such as “mouthpiece” in field 75 and click on search button 77. The system then displays only those noun groups or components with “mouthpiece” in them regardless of the appearance or absence of the respective RN. For example, in the subject patent, a “mouthpiece” search would produce a component list as follows:

+“mouthpiece 16”

+“hollow mouthpiece 16”

+“all forces driving mouthpiece 16”

+“dimensions of mouthpiece 16”

+“wind channel 17 of mouthpiece 16”

+“cavity 32, mouthpiece channel 28 and exit port 30”

User can select (click on) any of these component entries and the system responds the same as described below for selecting an entry from the full component list. The full list can again be displayed by user clicking on restore button 79. As mentioned above, if the system is in the “listen” mode, user can simply say the words “search (pause) mouthpiece” or “restore” instead of using keyboard and mouse commands.

In the example shown in FIG. 12 user selected “mouthpiece 16”. In response the system displays the text segment in window 70 that includes the first occurrence of “mouthpiece 16” and preferably positions the sentence including that specific noun group in the center of the window, and also preferably highlights the selected noun group (component). This enables the user to quickly find the selected component in the text and to read the text that comes before and after the selected component noun group. In addition, scroll control slide button 76 enables user to scroll fore and aft throughout the entire text, if desired. In addition, the system identifies all the other components identified in the linking index such as by underlining them or displaying them in a distinct color from all other text.

The system can also automatically display the graphic segment of the first sheet of drawings that includes the reference number “16” as shown in FIG. 12 window 68. The graphic segment can be displayed in response to user selection of the component in window 66 and/or user selection (click on) of the component in the text in window 70. FIG. 12 shows the situation in which user clicked on component “16” either in window 66 or the window 70. User can scroll through the displayed drawing sheet with the use of right-left, up-down slide buttons 78 and 80, as desired. The system also identifies for user convenience all the RN's in the displayed graphic that appears in the linking index by showing them in a distinctive color or by placing a circle or black square about them in the graphic. Since “16” is part of the component selected by user to display the segment shown in window 68 FIG. 12, the system highlights “16” in the graphic by, for example, placing a red square around it in the graphic.

Because the system stores the linking data among all occurrences of the RNs, the system enables user to jump to various sentences of the text in which any selected RN appears. For example, user can click on (select) “16” in FIG. 12 window 68 and in response the system displays the small sub-window 82 in which the system displays all the noun groups throughout the text that include RN “16”. The system enables user to listen to any of the sentences that include the respective noun group listed in sub-window 82 in response to user selecting (clicking on) the speaker icon 83 at the end of the noun group of interest. Sub-window 83 can be moved by user by standard click-and-drag routines as desired.

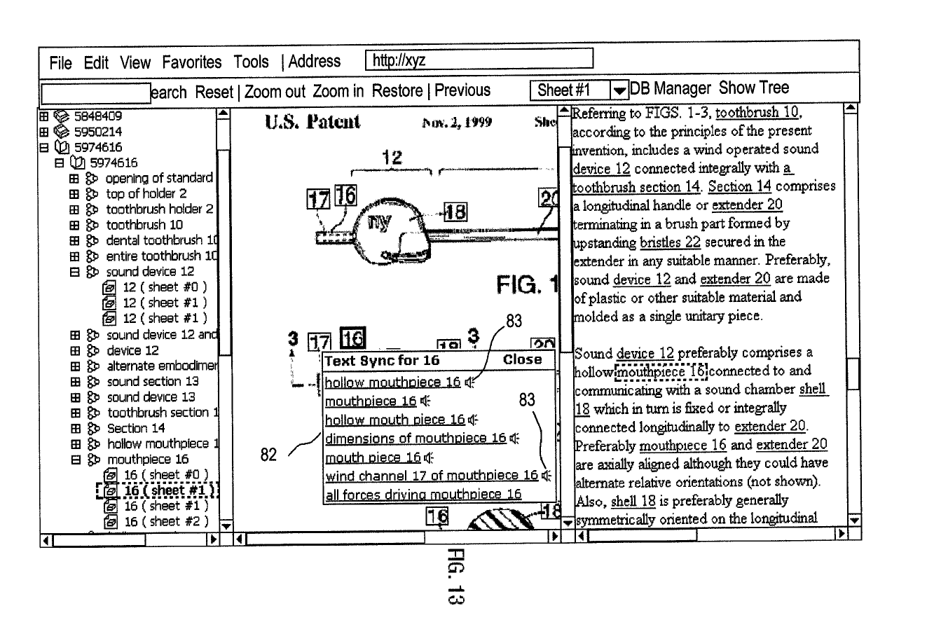

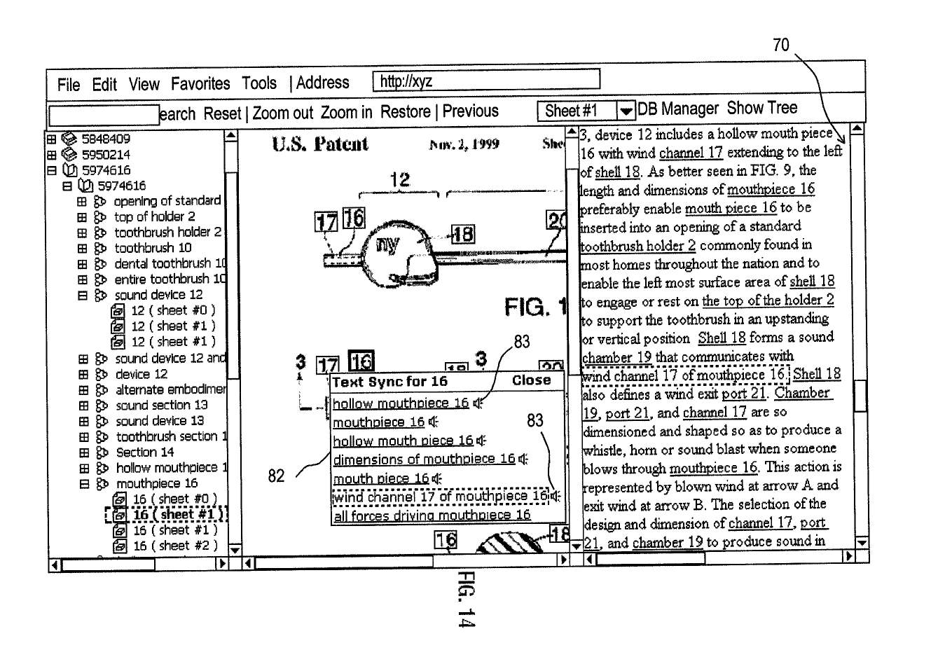

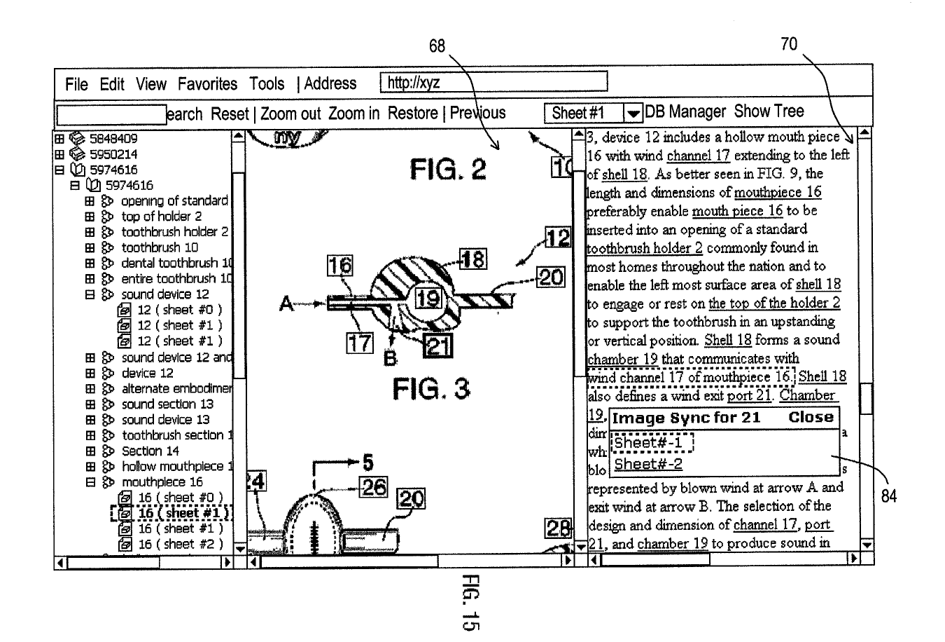

The system enables user to select any one of the listed noun groups in sub-window 82 by clicking on the specific noun group to initiate the new text display of the respective text segment that includes that specific noun group selected. For example, if user selects “wind channel 17 of mouthpiece 16” in window 82 of FIG. 13, then the system will immediately display the text shown in window 70 of FIG. 14. If user, in reading this text, becomes interested in “port 21”, user can see it is highlighted and, therefore, can select it to display immediately sub-window 84 that lists all sheets of drawings that include “21”. User can select the desired sheet number by clicking on it in window 84 and the graphic in window 68 immediately changes to that shown in FIG. 15 with component “21” preferably in the center of the window, a red square around “21”, and a light black square around “16” because now “21” was selected by the user. See FIG. 15.

It will be understood that the system enables user to quickly access the graphic and text segments of interest to user, to quickly jump to new areas of text and new areas of graphics of interest to user in a user controlled, text-graphic integrated manner for the rapid understanding and managing of the document data segments displayed on the monitor. In addition, user can print in color any screen shot desired through standard word processing programs such as Microsoft Word, etc. In addition, the system can include the zoom in-out features and the “speak” and “listen” features mentioned above, as desired.

Sub-Windows 82 and 84 can be closed in any suitable manner, such as by moving the curser across the “close” word in the title bar. They can be placed in any suitable location on the monitor and need not cover the any portion of the graphic segment or text segment, if desired. Alternately, they can be located within the component list window 66 after user accesses a text and a graphic segment or some other suitable location in the display.

It will be understood that besides patent documents, various other types of natural language and graphic documents can be analyzed according to the present invention, such as (without limitation) technical articles with graphics having certain parts labeled, medical, financial, and business documents with body parts, graphs, charts, tables with segments labeled, etc. These labels (e.g. words) would be used as and function as reference symbols (RS), the same as the patent reference numbers (RNs) mentioned above to integrate the text and graphic analysis.

It will also be understood that various features and functions disclosed herein can be employed in various combinations and/or be implemented under the control and selection of the user and that the present invention is not limited to the precise exemplary steps disclosed herein for user management of displayed information. For example, instead of a speak icon in sub-window 82, the system can be programmed to speak the sentence in response to the first click on a particular component and display the new text segment in window 70 in response to the second click of such component.

Glossary

Graphics segment—a portion of a graphic that includes an RS.

Index or Linking Index—computer resident data bases and/or files and routines that associate or cross link information such as described in FIG. 2A hereof.

Intersection—where a graphic segment and text segment include a common RS.

Noun group—a word or group of words that include a component name associated with an RS. The noun group may or may not include the RS so long as one occurrence in the text includes the RS.

Normalizing/group component names—changing nouns to a standard term (such as “mouthpieces” to “mouthpiece” or “entire toothbrush 10” to “toothbrush 10”) and grouping several occurrences of a term into a master term with links to the specific terms.

Quotation marks (“x”)—RN and Figure numbers in U.S. Pat. No. 5,974,616.

Reference Number (RN)—an RS that includes a number

Reference Symbol (RS)—letter(s), word(s), number(s) or combination thereof that are used to designate a feature, component, or item in a document text and/or graphic.

Selection of RS—user selection (e.g., click on) of a displayed RS or a noun group associated with such RS or user voice recognition command and word.

“Sheet #0”—the cover sheet for the patent as distinct from a full sheet of drawings in, for example, a U.S. Patent.

Sub-window—a pop-up small window.

Table or linking table—linking index.

Text segment—a group of words from at least part of a sentence which may or may not include an RS.

We claim:

1. A computer system based method of analyzing an electronic document that includes text and graphics and in which common reference symbols designate text components and respective graphics components, the method comprising
processing the document text into an index that identifies the text locations of reference symbols
processing the document graphics into an index that identifies the graphic locations of reference symbols, and
displaying the text that includes at least some of the text reference symbols or displaying at least some of the graphic reference symbols, and
linking the common text and common graphic reference symbols such that user selection of a particular text reference symbol or graphic reference symbol causes display of a respective graphic segment or text segment that includes the selected common reference symbol.

2. The method according to claim 1 wherein each graphic reference symbol includes one or a combination of number(s), letter(s), and word(s).

3. The method according to claim 1 wherein each text reference symbol includes one or a combination of number(s), letter(s), and word(s).

4. The method according to claim 1 wherein each text reference symbol includes one or a combination of number(s), letter(s), and word(s)and each graphic symbol includes one or a combination of number(s), letter(s), and word(s)and wherein each common text and graphic reference symbol includes the same one or a combination of number(s), letter(s), and word(s) respectively.

5. The method according to claim 1 further comprising,
highlighting displayed text reference symbols which are linked to graphic reference symbols.

6. The method according to claim 1 further comprising,
highlighting displayed graphic reference symbols which are linked to text reference symbols.

7. The method according to claim 5 further comprising,
displaying all corresponding graphic segments in response to user selection of a particular displayed text reference symbol and wherein each corresponding graphic segment includes the reference symbol common to said selected text reference symbol.

8. The method according to claim 5 further comprising,
displaying the locations or sheet numbers of corresponding graphic segments in response to user selection of a particular displayed text reference symbol and wherein each corresponding graphic segment includes the reference symbol common to said selected text reference symbol.

9. The method according to claim 8 further comprising,
displaying the corresponding graphic segment in response to user selection of a particular displayed reference symbol location or sheet number.

10. The method according to claim 1 further comprising,
highlighting displayed graphic reference symbols which are linked to text reference symbols.

11. The method according to claim 1 further comprising,
highlighting displayed text reference symbols which are linked to graphic reference symbols.

12. The method according to claim 10 further comprising,
displaying all corresponding text segments in response to user selection of a particular displayed graphic reference symbol and wherein each corresponding text segment includes the reference symbol common to said selected graphic reference symbol.

13. The method according to claim 10 further comprising,
displaying the corresponding text segments in response to user selection of a particular displayed graphic reference symbol and wherein each corresponding text segment includes the reference symbol common to said selected graphic reference symbol.

14. The method according to claim 13 further comprising,
displaying the corresponding text segment and preceding and following text thereof in response to user selection of a particular displayed text segment.

15. The method according to claim 1 further comprising,
displaying a list that includes the text identities of components and the reference symbol associated with each text component.

16. The method of claim 15 wherein the list is arranged in alphabetical order of component text identities or in order of the reference symbol associated with each text component.

17. The method of claim 15 wherein each component text identity comprises a noun group.

18. The method of claim 15 wherein user selection of a component text identity in the displayed list causes display of a text segment that includes the selected component text identity.

19. The method of claim 18 wherein the full document text displayed is forward/backward scrollable by user command.

20. The method of claim 18 wherein the list, graphic, and text are displayed in separate windows the area of which windows are variable by user command.

21. The method of claim 1 further comprising synthesizing a user selected text segment or the sentence in which a user selected text segment appears, and converting the synthesized text segment or sentence into an audible segment or sentence audible to the user.

22. The method of claim 21 wherein the graphic is displayed during the time the audible segment or sentence is audible to user.

23. The method of claim 1 wherein user selection includes user speaking an audible command and using voice recognition methods to convert the audible command into a digital computer instruction.

24. The method of claim 1 wherein the displayed text segment is displayed as part of the document text and the displayed document text is scrollable, fore and aft, in response to user command.

25. The method of claim 24 wherein the user display includes at least two windows, a text window and a graphics window, and the selected and displayed text segment is initially displayed in the vertical mid-region of the text window.

26. The method of claim 1 wherein the displayed graphic segment is displayed as part of the document graphic and the displayed document graphic is zoomable, inward and outward, in response to user command.

27. The method of claim 24 wherein the user display includes at least two windows, a text window and a graphics window, and the selected and displayed graphic segment is initially displayed in the vertical mid-region of the graphic window.

28. The method of claim 8 wherein said locations or sheet numbers are displayed in a sub-window.

29. The method of claim 13 wherein said corresponding text segments are displayed in a sub-window.

30. The method of claim 1 further including displaying simultaneously the text segment and the graphic segment that include the selected common reference symbol.

31. The method of claim 30 further including printing or storing in a separate file, the simultaneously representations of displayed text segment and graphic segment.

32. The method of claim 1 further comprising storing the text locations of all sentences and word in the document.

33. The method of claim 32 further comprising synthesizing the sentence in which a predetermined word appears in response to user selection of said predetermined word, and converting the sentence into an audible series of words representing said sentence.

34. The method of claim 33 wherein said user selection includes the user speaking a predetermined command and said predetermined word and, using voice recognition methods, converting the spoken predetermined command and said predetermined word into a digital computer instruction.

35. The method of claim 34 wherein the predetermined word is or is not associated with a reference symbol.

36. Systems and methods as substantially disclosed herein.
